(19) United States
(12) Patent Application Publication
(10) Pub. No.: US 2011/0227695 A1
(43) Pub. Date: Sep. 22, 2011

(54) Remote control system of outdoor shading group

(76) Inventor: Wanda Ying Ll, Irvine, CA (US)

(21) Appl. No.: 12/661,605

(22) Filed: Mar. 19, 2010

(51) Int. Cl. G08C 13/00; E04H 15/02

(52) U.S. Cl. 340/4.3; 135/96

(57) ABSTRACT

A remote control system for controlling two or more outdoor shading devices includes a plurality of control modules providing at the outdoor shading devices respectively to control an operation of the outdoor shading devices, and a central control unit remotely linked to the control modules to form a control network of the outdoor shading devices, wherein the central control unit is adapted for synchronously activating the outdoor shading devices to concurrently control the operation of the outdoor shading devices in responsive to an environmental change of the control network. Therefore, the outdoor shading devices are synchronously operated to optimize the performance thereof.

### BACKGROUND OF THE PRESENT INVENTION

1. Field of Invention

The present invention relates to control system of outdoor shading device, and more particularly to a central control system for concurrently controlling two or more outdoor shading devices, wherein each of the outdoor shading devices comprises a shading system and a functional controller electrically linking to the central control system, such that the central control system is able to synchronously control a group of outdoor shading devices.

2. Description of Related Arts

Outdoor shading devices are usually provided in a campground, on a beach, or in the back yard of the house to give a pleasant shade for a user under the sun. Usually, the user uses the outdoor shading device especially on a sunny day to prevent the sunlight directly projecting on the user, or rainy day to prevent the user being soaked. The outdoor shading devices are also commonly provided at outdoor seating area of a restaurant, so that the customer is able to enjoy the meal in the outdoor atmosphere under the shading device.

A conventional shading device, such as a conventional outdoor umbrella, generally comprises a supporting frame and a shading system supported by the supporting frame to define the predetermined shading area under the shading system. Over the years, there have been extensive developments for improving the quality and functions of such conventional shading device. For example, an outdoor umbrella may be equipped with a solar energy collection arrangement and a lighting system for providing environmental friendly illumination for the relevant users. Moreover, another shading device, such as a conventional gazebo, may be equipped with a specially designed ventilation system so that users of the gazebo have adequate access to fresh air when they are gathering within the gazebo while preserving their privacy.

Notwithstanding these developments, conventional shading devices, even with some sophisticated improvements, such as the above mentioned lighting system and the ventilation system, are usually not responsive enough to the change of environmental circumstances in which the shading devices operate. This discrepancy may be partially resolved by manual operation of the shading devices. For example, a user may easily turn on or turn off the illumination system whenever necessary. In some situations, however, frequent manual operation of the shading system may mean inconvenience and interruption of a scheduled activity in the shading system.

A good example is that when a user utilizes an outdoor umbrella in a very sunny environment, he or she may need to adjust the angle of inclination of the awning frame in relation to the sun light projecting angle, so as to provide an optimal sun shading effect. However, as time goes by, the angle of inclination of the awning frame may need adjustment because of the change of position of the sun throughout the day. As a result, in order to keep the same standard of sun shading quality of the sun shading system, the user may have to manually adjust the angle of inclination of the awning frame so that the angle of inclination always corresponds with the sun position. This imparts extreme inconvenience on the part of the user or the one who is responsible for adjusting the angle of the awning frame.

Moreover, some places, such as restaurant outdoor seating area, may have a group of outdoor umbrellas as the outdoor shading devices. The servers of the restaurant may have to individually adjust each of the outdoor shading devices in order to provide the optimal shading effect for the customers. Therefore, it is exhausted that the servers of the restaurant have to independently adjust each of the shading devices every certain time period in order to provide the optimal shading effect for their customers. At the beginning or the end of the day, the servers may also have to unfold or fold each of the outdoor umbrellas manually.

### SUMMARY OF THE PRESENT INVENTION

An object of the present invention is to provide a remote control system, which is able to centrally control a group of outdoor shading devices in a concurrent manner.

Another object of the present invention is to provide a remote control system, which is able to synchronously activate a group of outdoor shading devices via a central control unit.

Another object of the present invention is to provide a remote control system, wherein the central control unit enables to activate the outdoor shading devices from a predetermined distance by wiring connection or wirelessly, so that it is unnecessary for a user to operate each of individual outdoor shading devices.

Another object of the present invention is to provide a remote control system, wherein two or more outdoor shading devices are being synchronously operated between a folded and unfolded position at the same time.

Another object of the present invention is to provide a remote control system, wherein the environmental sensing module of the remote control system enable the shading devices self-adjusted to provide an optimal shading area thereunder.

Another object of the present invention is to provide a remote control system, wherein the personal preference setting allows the user adjustably controlling the shading devices based on their preferences.

Another object of the present invention is to provide a remote control system, wherein a connecting arrangement is able to electrically linking two or more shading devices to the central control unit to form a shading device network for centrally controlling a group of shading devices.

Another object of the present invention is to provide a remote control system, wherein a wireless linking module of the connecting arrangement is able to centrally control a group of shading devices in the wireless manner, so as to eliminate a pre-wiring process for electrically connecting the central control unit with the group of shading devices via wires.

Accordingly, in order to accomplish the above objects, the present invention provide a remote control system for controlling outdoor shading group, which comprises two or more shading devices, a central control unit for synchronously and remotely control each of the shading device, and a connecting arrangement for electrically linking the central control unit to each of the shading devices, so as to form a shading devices network.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of the remote control system according to a preferred embodiment of the present invention, illustrating the remote control system synchronously operating the group of outdoor shading devices.

FIG. 2 is a perspective view of the outdoor shading device incorporating with the remote control system according to the above preferred embodiment of the present invention.

FIG. 3 is a block diagram of remote control system according to the above preferred embodiment of the present invention, illustrating the environmental sensor device incorporating with the outdoor shading device.

FIG. 4 is a flow chart of a remote control method for controlling two or more shading devices according to the preferred embodiment of the present invention.

### DETAILED DESCRIPTION OF THE PREFERRED EMBODIMENT

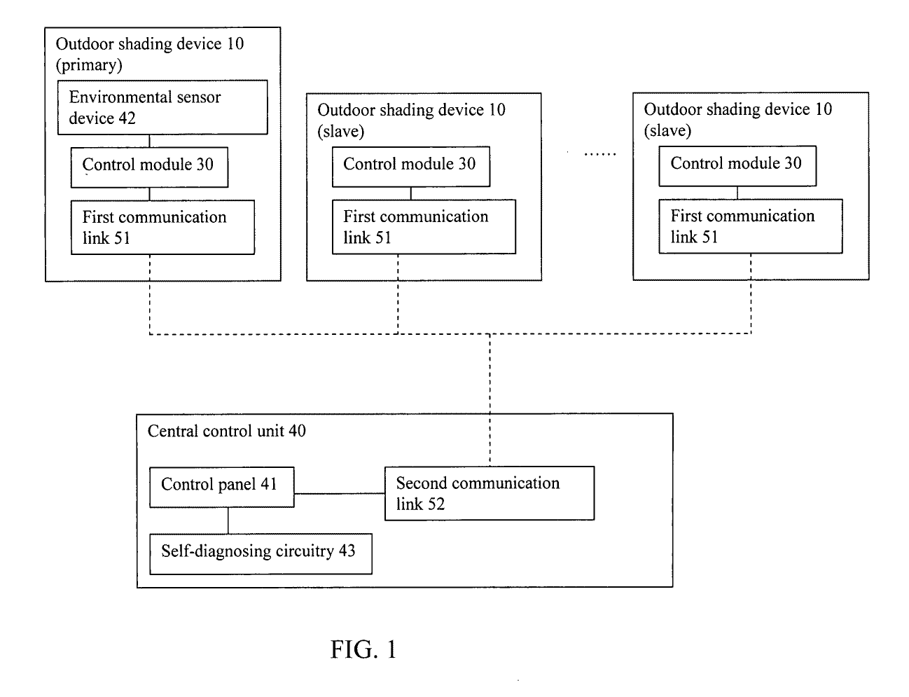

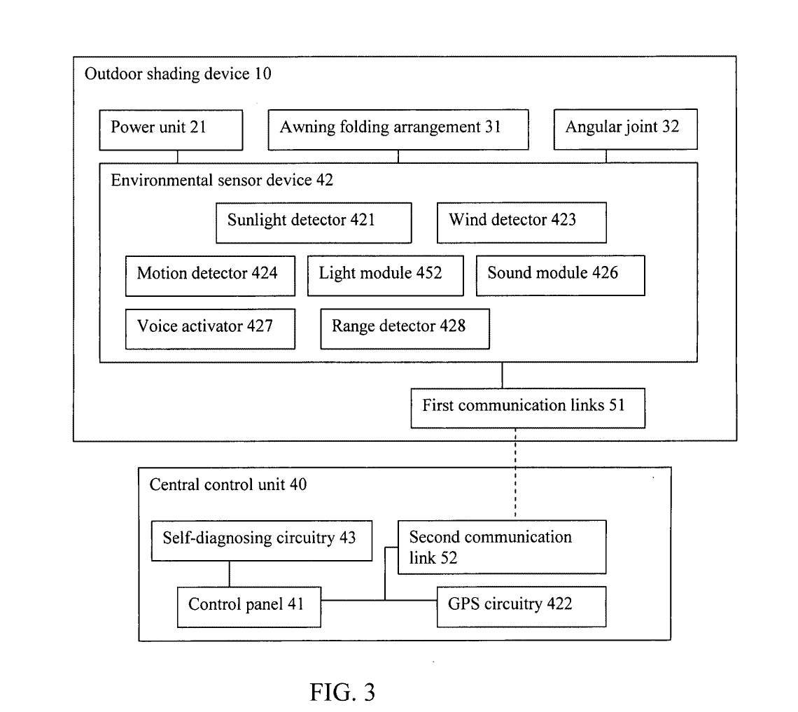

Referring to FIGS. 1 to 3 of the drawings, an outdoor shading system according to a preferred embodiment of the present invention is illustrated, wherein the outdoor shading system comprises two or more outdoor shading devices 10 and a remote control system 20 operatively linked to the outdoor shading devices 10 for centrally controlling the outdoor shading devices 10 in a remotely manner, so that a user of the outdoor shading devices is able to remotely control the outdoor shading devices while being time effectively.

According to the preferred embodiment, each of the outdoor shading devices 10, which is embodied as a conventional outdoor umbrella, comprises a supporting frame 11 and an awning frame 12 movably supported by the supporting frame 11 to define a shading area under the awning frame 12.

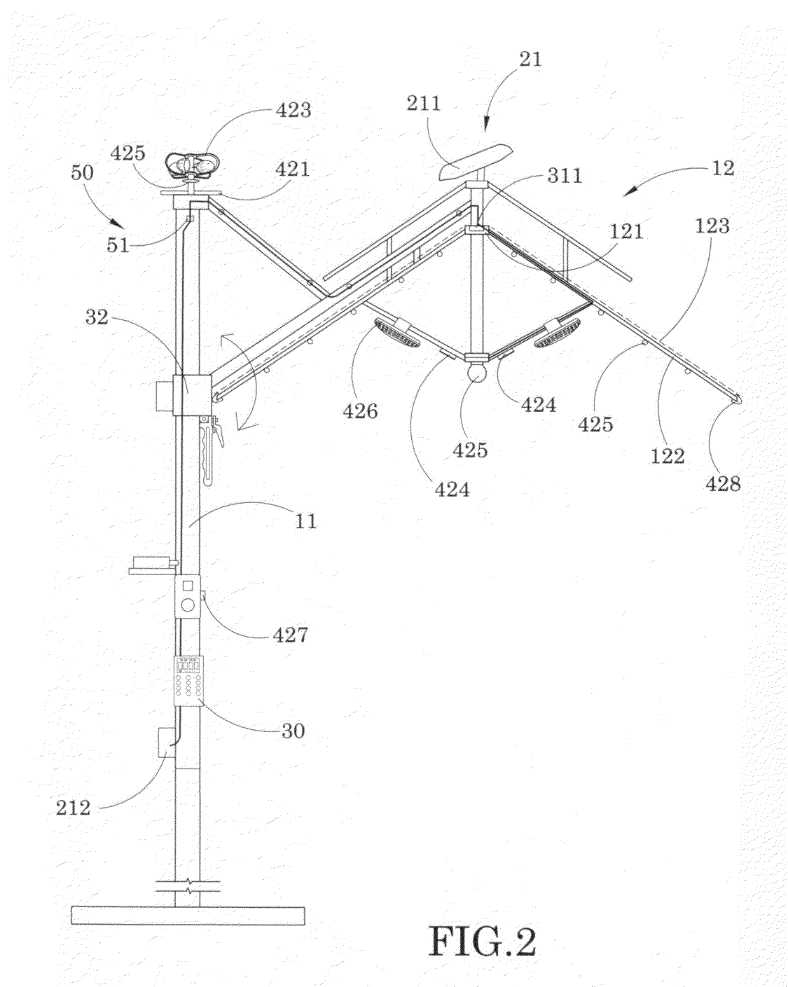

As shown in FIG. 2, the awning frame 12 comprises a housing 121 suspendedly supported by the supporting frame 11, a plurality of awning arms 122 radially and pivotally coupling with the housing 121, and an awning shelter 123 supported by the awning arms 122 to define the shading area under the awning shelter 123. It is worth mentioning that the awning frame 12 of each of the outdoor shading devices 10 is adapted to fold between a folded position and an unfolded position. At the folded position, the awning arms 122 are pivotally moved with respect to the housing 121 at a position that the awning shelter 123 is folded up to minimize the shading area thereof. At the unfolded position, the awning arms 122 are pivotally moved at a position that the awning shelter 123 is expanded to maximize the shading area thereof.

The remote control system 20 comprises a power unit 21 and a plurality of control modules 30 provided at the outdoor shading devices 10 to electrically connect to the power units 21 respectively, wherein an operation of each of the outdoor shading devices 10 is controlled by the respective control module 30.

The remote control system 20 further comprises a central control unit 40 remotely linked to the control modules 30 to form a control network of the outdoor shading devices 10, wherein the central control unit 40 synchronously activates the control modules 30 to concurrently control the operation of the outdoor shading devices 10 in responsive to an environmental change of the control network.

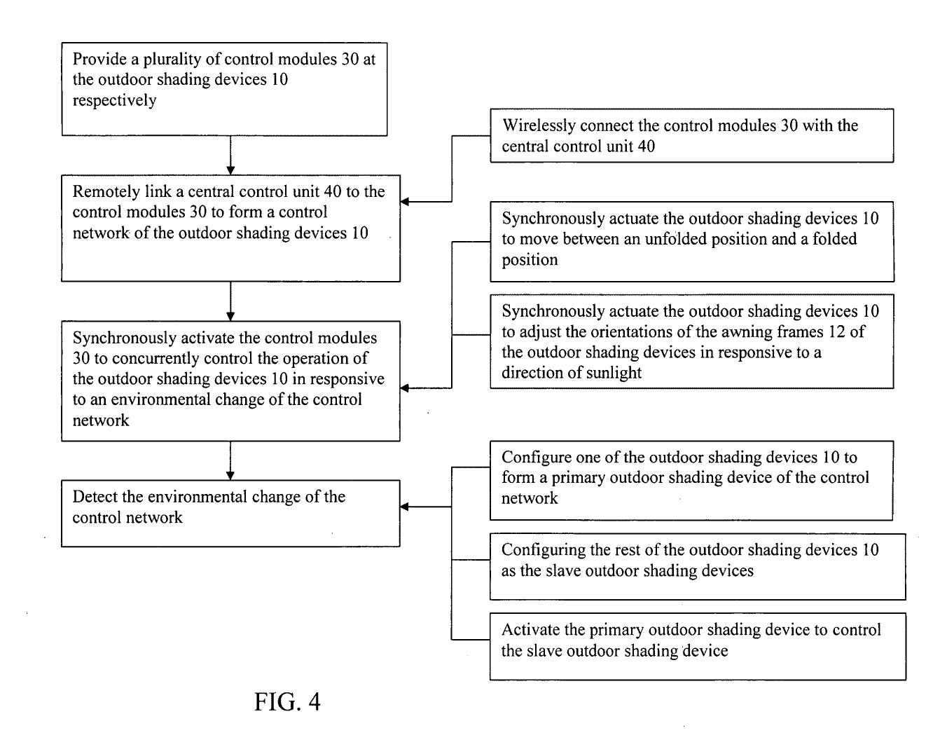

As shown in FIG. 4, the present invention also provides a method of remotely controlling a group of outdoor shading devices 10, which comprises the following steps.

(1) Provide the control modules 30 at the outdoor shading devices 10 respectively. Accordingly, the control modules 30 can be built-in with the outdoor shading devices 10 respectively that each of the outdoor shading devices 10 already has the control module 30 to control the operation. Alternatively, the control module 30 can be an external device added-on to each of the outdoor shading devices 10.

(2) Remotely link the central control unit 40 to the control modules 30 to form the control network of the outdoor shading devices 10.

(3) Synchronously activate the control modules 30 to concurrently control the operation of the outdoor shading devices 10 in responsive to the environmental change of the control network.

According to the preferred embodiment, each of the control modules 30 comprises an awning folding arrangement 31 operatively linked to the awning frame 12 of the respective outdoor shading device 10 to selectively actuate the awning frame 12 between the unfolded position and the folded position. The awning folding arrangement 31 comprises an electro servo 311 electrically powered by the respective power unit 21 to drive the awning arms 122 to move between the unfolded position and the folded position. It is worth mentioning that when the central control unit 40 is remotely activated, the outdoor shading devices 10 within the control network are synchronously actuated to move between the unfolded position and the folded position, as in the step (3).

Each of the control modules 30 further comprises an angular joint 32 which is powered by the respective power unit 21 and is coupling at the awning frame 12 of the respective outdoor shading device 10 to selectively adjust an orientation of the awning frame 12 in responsive to a direction of sunlight. Therefore, the awning frame 12 can be adjusted to face towards the direction of the sun for maximizing the shading effect of the awning frame 12. Accordingly, when the central control unit 40 is remotely activated, the outdoor shading devices 10 are synchronously actuated to adjust the orientations of the awning frames 12 of the outdoor shading devices 10, as in the step (3).

In other words, the central control unit 40 forms a central controller to concurrently operate all the outdoor shading devices 10 within the control network at the same time. Accordingly, the central control unit 40 comprises a control panel 41, having a plurality of preference settings, remotely linked to control modules 30 for synchronously activating the outdoor shading devices 10 in responsive to the preference settings.

In order to utilize an environmentally friendly power source as the power unit 21 of the present invention, the power unit 21 comprises a plurality of solar energy collecting panels 211 supported above the awning frame 12 for collecting solar energy and converting the solar energy into electrical energy, and a power storage 212 operatively connected to the solar energy collecting panels 211 for storing the electrical energy. Accordingly, the power storage 212 can be supported at each of the outdoor shading devices 10 for supplying energy to the corresponding control module 30. Alternatively, the power storage 212 can be located away from the outdoor shading devices 10.

Accordingly, the user is able to select one of the preference settings at the control panel 41 to selectively operate the designated outdoor shading devices 10. For example, when the control panel 41 is activated, such as a “POWER” key is activated, all the outdoor shading devices 10 are set at the standby mode. When an “ON” key is activated on the control panel 41, all the outdoor shading devices 10 will be automatically operated to move the awning frames 12 at the unfolded position. When an “OFF” key is activated on the control panel 41, all the outdoor shading devices 10 will be automatically operated to move the awning frames 12 at the folded position.

The central control unit 40 comprises an environmental sensor device 42 operatively linked to the control modules 30 for detecting the environmental change of the control network in such a manner that the outdoor shading devices 10 are synchronously activated to be operated to automatically adjust the awning frame 12 in responsive to the environmental change of the control network.

Accordingly, the environmental sensor device 42 is arranged to gather a plurality of environment factors and transmit the corresponding signal of the environment factors information to the control module 30 for being processed, so that the control module 30 send out a related signal to activate the corresponding shading devices 10 in responsive to the information gathered via the environmental sensing device 42.

According to the preferred embodiment, the environmental sensor device 42 is supported at one of the outdoor shading devices 10 to form a primary outdoor shading device of the control network. The rest of the outdoor shading devices become a plurality of slave outdoor shading devices 10, wherein when the primary outdoor shading device 10 is activated to be operated in responsive to the environmental change of the control network, the slave outdoor shading devices 10 are correspondingly operated in relation to the primary outdoor shading device 10. In other words, the user is able to pick one of the outdoor shading devices 10 to become the primary outdoor shading device 10 by locating the environmental sensor device 42 thereat to minimize the material cost of the environmental sensor device 42 incorporating with all the outdoor shading devices 10. It is appreciated that each of the outdoor shading devices 10 can incorporate with its own environmental sensor device 42 such that each of the outdoor shading devices 10 can be self adjusted in responsive to its own environmental sensor device 42 while all the outdoor shading devices 10 can be centralized and controlled by the central control unit 40. In addition, the environmental sensor device 42 can be provided at an individual tower which is located away from the outdoor shading devices 10 for detecting the environmental change of the control network. Therefore, the environmental sensor device 42 can precisely detect the environmental change to regulate the outdoor shading devices 10.

Accordingly, the configuration of the control network in responsive to the detection of the environmental change of the control network via the environmental sensor device 42 comprises the following step.

(4.1) Configure one of the outdoor shading devices 10 to form the primary outdoor shading device of the control network by locating the environmental sensor device 42 thereat.

(4.2) Configure the rest of the outdoor shading devices 10 as the slave outdoor shading devices.

(4.3) Activate the primary outdoor shading device 10 to be operated through the central control unit 40 in responsive to the environmental change of the control network, wherein the slave outdoor shading devices 10 are correspondingly operated in relation to the primary outdoor shading device 10.

According to the preferred embodiment, the environmental sensor device 42 comprises a sunlight detector 421, a GPS circuitry 422, a wind detector 423, a motion detector 424, a light module 452, and a sound module 426.

The sunlight detector 421 is adapted for detecting the direction of sunlight, wherein the sunlight detector 421 is provided at one of the outdoor shading devices 10, i.e. the primary outdoor shading device. Preferably, the sunlight detector 421 is placed above the awning frame 12 at a position on top of the supporting frame 11 and is operatively linked to the central control unit 40 such that when the sunlight detector 421 detects the direction of the sun, the central control unit 40 will receive the detection signal from the sunlight detector 421 to synchronously activate the outdoor shading devices 10 so as to automatically adjust the awning frame 12 in responsive to the direction of the sun for enhancing the shading effect of each of the outdoor shading devices 10. Accordingly, the sunlight detector 421 can be embodied as a GPS device coupled at the primary outdoor shading device 10.

Likewise, the GPS circuitry 422 is adapted for automatically tracking the direction of the sun so as to define the geographical location of the sun. The GPS circuitry 422 can be built-in with the central control unit 40 such that the GPS circuitry 422 will send out the GPS signal to the central control unit 40 to automatically adjust the awning frame 12 in responsive to the direction of the sun for enhancing the shading effect of each of the outdoor shading devices 10.

The wind detector 423 is arranged for detecting the direction of the wind loading at the awning frame 12, wherein the wind detector 423 is provided on top of one of the outdoor shading devices 10, i.e. the primary outdoor shading device. Preferably, the wind detector 423 is placed above the awning frame 12 at a position on top of the supporting frame 11 and is operatively linked to the central control unit 40. When the wind detector 423 detects the direction of the wind, the central control unit 40 will receive the detection signal from the wind detector 423 to synchronously activate the outdoor shading devices 10 so as to automatically adjust the awning frame 12 via the corresponding awning folding arrangement 31 and angular joint 32. Therefore, the awning frame 12 of each of the outdoor shading devices 10 will be self-adjusted to minimize the wind loading at the awning frame 12 or to fold up the awning frame 12 so as to avoid the outdoor shading device 10 to be accidentally flipped over and causing personal injuries. The wind detector 423 can be a conventional mechanical type wind detector which is capable of detecting the velocity of the incoming wind so that it can transmit the corresponding detection signal to the central control unit 40 when the adjustment of angle of inclination of the awning frame 12 is necessary. It is worth mentioning that the central control unit 40 will optimize the operation of the outdoor shading devices 10 that when the velocity of the wind is higher than a preset threshold, all the outdoor shading devices 10 will be automatically folded at the folded position. Otherwise, the outdoor shading devices 10 will be automatically self-adjusted to minimize the wind loading at the awning frames 12.

The motion detector 424 is arranged for detecting the presence of a user within a detecting area of the respective outdoor shading device 10, wherein the motion detector 424 is preferably mounted at the awning frame 12 of each of the outdoor shading devices 10 within the shading area and is operatively linked to the central control unit 40. Therefore, when the motion detector 424 detects the presence of the user within the detecting area of the respective outdoor shading device 10, the outdoor shading device 10 will be automatically folded to its unfolded position. Once the user leaves the outdoor shading device 10, i.e. out of the detecting area of the motion sensor 424, the outdoor shading device 10 will be automatically folded to its folded position.

The light module 425 is arranged for detecting a light level of an environment of the outdoor shading device 10 to illuminate the shading area thereof, wherein the light module 425 is preferably provided at the awning frame 12 within the shading area thereof and is operatively linked to the central control unit 40. Preferably, the light module 425 comprises a photosensor placed on top of the supporting frame 11 for detecting a light brightness of the shading area, and an illumination unit which is supported by the awning frame 12 within the shading area and is arranged in such a manner that when the light brightness of the shading area detected by the photosensor is lower than a preset light level threshold, the illumination unit is activated for providing extra illumination to the shading area. Once the ambient brightness of the shading area is above the threshold, the illumination unit is deactivated. Accordingly, the illumination unit can be a conventional light bulb, or a plurality of LEDs for providing optimal illumination to the shading area.

The sound module 426 is arranged for generating an audio effect when the respective outdoor shading device 10 is in use, wherein the sound module 426 comprises an audio speaker supported at the awning frame 12 of each of the outdoor shading devices 10 and operatively linked to the central control unit 40 for delivering audible sound to the outdoor shading device 10 when the sound module 426 is activated. It is worth mentioning that the light module 425 and the sound module 426 are preferably activated by the central control unit 40 when the respective outdoor shading device 10 is folded at its unfolded position. Once the outdoor shading device 10 is folded at its folded position, i.e. the outdoor shading device 10 is not in use, the light module 425 and the sound module 426 are deactivated by the central control unit 40.

It is appreciated that the environmental sensor device 42 further comprises a voice activator 427 and a range detector 428. The voice activator 427 is mounted at each of the outdoor shading devices 10 and is operatively linked to the central control unit 40, such that when the voice activator 427 detects an audio command, the light module 425 and the sound module 426 are activated for generating illumination and audio effect respectively.

The range detector 428 is preferably mounted at each of the outdoor shading devices 10 at the awning frame 12 and is operatively linked to the central control unit 40 for detecting the presence of the user within an awing folding range of the respective outdoor shading device 10. Therefore, at the time the range detector 428 detects the presence of the user when the awning frame 12 is folded between the folded position and the unfolded position, the awning folding arrangement 31 will be automatically deactivated to stop the folding movement of the awning frame 12 for safety purpose.

As it is mentioned above, the user is able to select one of the preference settings at the control panel 41 to selectively operate the designated outdoor shading devices 10. The central control unit 40 is selectively activated through the preference settings of the control panel 41 to activate all the outdoor shading devices 10 at the standby mode. At the standby mode, each of the outdoor shading devices 10 will be self-adjusted in responsive to its own setting. For example, the motion detector 424 will be activated to determine whether the respective outdoor shading device 10 needs to be folded at its unfolded position. Once the outdoor shading device 10 is at its unfolded position, the light module 425 and the sound module 426 will be activated automatically. The sunlight detector 421, the GPS circuitry 422, and the wind detector 423 will be activated when the outdoor shading devices 10 are folded at the unfolded position. Therefore, the central control unit 40 will provide an intelligent control system to monitor and control the outdoor shading devices 10. It is appreciated that the central control unit 40 can concurrently control all the control modules 30 to fold and unfold the outdoor shading devices 10. Preferably, a timer module can be built-in the central control unit 40 to operate the outdoor shading devices 10 in a timely manner.

For example, when some of the outdoor shading devices 10 are not in use at the outdoor area of the restaurant, the vacated outdoor shading devices 10 will be automatically folded up to prevent the view from being blocked, while the vacated outdoor shading devices 10 will also save the energy by setting them at the low-powered status.

According to the preferred embodiment, the remote control system 20 further comprises a wireless link 50 for wirelessly connecting the control modules 30 with the central control unit 40 to form the control network in a wireless manner. The wireless link 50 comprises a plurality of first communication links 51 operatively linked to the control modules 30 respectively, and a second communication link 52 operatively linked to the central control unit 40 to wirelessly communicate with the first communication links 51, such that the central control unit 40 synchronously activates the outdoor shading devices 10 to concurrently control the operation of the outdoor shading devices 10 in a wireless manner.

Accordingly, the central control unit 40 is able to wirelessly transmit the wireless control signal to the control modules 30 for synchronously controlling the outdoor shading devices 10. It is worth to mention that the first and second communication links 51, 52 can be wirelessly linked by infrared or radio frequency (RF), which has a relatively wider range of electromagnetic radiation, so that the wireless control signal of the remote control system 20 is able to cover longer distance in the wireless manner, so as to enhance the signal transmitting quality thereof. Thus, the first and second communication links 51, 52 can simplify the installation and configuration of the remote control system 20 by eliminating the pre-wiring process thereof

According to the preferred embodiment, the central control unit 40 further comprises a self-diagnosing circuitry 43 operatively linked to the control modules 30 to perform a self-diagnosing test of each of the control modules 30. Therefore, the central control unit 40 can automatically determine when one of the outdoor shading devices 10 is malfunctioned.

The operation of the remote control system 20 of the present invention comprises the following steps.

(A) Activate the central control unit 40 to activate the control modules 30 such that all the outdoor shading devices 10 within the control network will be activated at the standby mode. Preferably, the self-diagnosing test will run at each of the control modules 30 when the control module 30 is activated.

(B) Select the preference settings at the control panel 41 according to the user preference.

In the step (B), the user is able to unfold all the outdoor shading devices 10 concurrently by one touch of the control panel 41 such that all the outdoor shading devices 10 are ready to use. Alternatively, each of the outdoor shading devices 10 will be remained at the unfolded position until the respective outdoor shading device 10 is needed to be used.

(C) Set the central control unit 40 at the “auto” mode that the central control unit 40 synchronously activates the control modules 30 to concurrently control the operation of the outdoor shading devices 10 in responsive to the environmental change of the control network.

Accordingly, at the “auto” mode, each of the control modules 30 can be individually operated to selectively operate the respective outdoor shading device 10 by switching the motion detector 424, the light module 452, and the sound module 426 in an on and off manner. In addition, at the “auto” mode, the control modules 30 are centralized and controlled by the central control unit 40 to activate the sunlight detector 421, the GPS circuitry 422, and the wind detector 423 so as to synchronously operate the outdoor shading devices 10. It is worth mentioning that the light module 452 and the sound module 426 can be controlled by the central control unit 40 such that the user is able to switch on and off the light module 452 and the sound module 426 by one touch of the control panel 41.

(D) Deactivate the central control unit 40 to switch off the control modules 30 such that all the outdoor shading devices 10 within the control network will be deactivated and will be folded back to the folded position.

It will be readily appreciated that remote control system 20 may comprise a plurality of communication wires being pre-wired for electrically connecting each of the control modules 30 and the central control unit 40 to communicatively operate the outdoor shading devices 10 via the central control unit 40.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An outdoor shading system, comprising:
a plurality of outdoor shading devices, wherein each of said outdoor shading devices comprises a supporting frame and an awning frame movably supported by said supporting frame to define a shading area under said awning frame; and
a remote control system, which is operatively linked to said outdoor shading devices, comprising:
a plurality of control modules provided at said outdoor shading devices respectively, wherein an operation of each of said outdoor shading devices is controlled by said respective control module; and
a central control unit remotely linked to said control modules to form a control network of said outdoor shading devices, wherein said central control unit synchronously activates said control modules to concurrently control said operation of said outdoor shading devices in responsive to an environmental change of said control network.

2. The outdoor shading system, as recited in claim 1, wherein each of said control modules comprises an awning folding arrangement operatively linked to said awning frame of said respective outdoor shading device to selectively actuate said awning frame between an unfolded position and a folded position, in such a manner that when said central control unit is remotely activated, said outdoor shading devices are synchronously actuated to move between said unfolded position and said folded position.

3. The outdoor shading system, as recited in claim 1, wherein each of said control modules comprises an angular joint coupling at said awning frame of said respective outdoor shading device to selectively adjust an orientation of said awning frame in responsive to a direction of sunlight, in such a manner that when said central control unit is remotely activated, said outdoor shading devices are synchronously actuated to adjust the orientations of said awning frames.

4. The outdoor shading system, as recited in claim 2, wherein each of said control modules comprises an angular joint coupling at said awning frame of said respective outdoor shading device to selectively adjust an orientation of said awning frame in responsive to a direction of sunlight, in such a manner that when said central control unit is remotely activated, said outdoor shading devices are synchronously actuated to adjust the orientations of said awning frames.

5. The outdoor shading system, as recited in claim 1, wherein said central control unit comprises a control panel, having a plurality of preference settings, remotely linked to control modules for synchronously activating said outdoor shading devices in responsive to said preference settings.

6. The outdoor shading system, as recited in claim 4, wherein said central control unit comprises a control panel, having a plurality of preference settings, remotely linked to control modules for synchronously activating said outdoor shading devices in responsive to said preference settings.

7. The outdoor shading system, as recited in claim 1, wherein said central control unit comprises an environmental sensor device operatively linked to said control modules for detecting the environmental change of said control network in such a manner that said outdoor shading devices are synchronously activated to be operated to automatically adjust said awning frame in responsive to the environmental change of said control network.

8. The outdoor shading system, as recited in claim 6, wherein said central control unit comprises an environmental sensor device operatively linked to said control modules for detecting the environmental change of said control network in such a manner that said outdoor shading devices are synchronously activated to be operated to automatically adjust said awning frame in responsive to the environmental change of said control network.

9. The outdoor shading system, as recited in claim 7, wherein said environmental sensor device is selected from the group consisting of a sunlight detector for detecting the direction of sunlight, a GPS circuitry for automatically tracking the direction of the sun, a wind detector for detecting the direction of the wind loading at said awning frame, a motion detector for detecting the presence of a user within a detecting area of said respective outdoor shading device, a light module for detecting a light level of an environment of said outdoor shading device to illuminate said shading area thereof, a sound module for generating an audio effect when said respective outdoor shading device is in use.

10. The outdoor shading system, as recited in claim 8, wherein said environmental sensor device is selected from the group consisting of a sunlight detector for detecting the direction of sunlight, a GPS circuitry for automatically tracking the direction of the sun, a wind detector for detecting the direction of the wind loading at said awning frame, a motion detector for detecting the presence of a user within a detecting area of said respective outdoor shading device, a light module for detecting a light level of an environment of said outdoor shading device to illuminate said shading area thereof, a sound module for generating an audio effect when said respective outdoor shading device is in use.

11. The outdoor shading system, as recited in claim 8, wherein said environmental sensor device is supported at one of said outdoor shading devices to form a primary outdoor shading device of said control network while the rest of said outdoor shading devices become slave outdoor shading devices, such that when said primary outdoor shading device is activated to be operated in responsive to the environmental change of said control network, said slave outdoor shading devices are correspondingly operated in relation to said primary outdoor shading device.

12. The outdoor shading system, as recited in claim 10, wherein said environmental sensor device is supported at one of said outdoor shading devices to form a primary outdoor shading device of said control network while the rest of said outdoor shading devices become a plurality of slave outdoor shading devices, such that when said primary outdoor shading device is activated to be operated in responsive to the environmental change of said control network, said slave outdoor shading devices are correspondingly operated in relation to said primary outdoor shading device.

13. The outdoor shading system, as recited in claim 1, wherein said remote control system further comprises a wireless link for wirelessly connecting said control modules with said central control unit to form said control network in a wireless manner, wherein said wireless link comprises a plurality of first communication links operatively linked to said control modules respectively, and a second communication link operatively linked to said central control unit to wirelessly communicate with said first communication links, such that said central control unit synchronously activates said outdoor shading devices to concurrently control said operation of said outdoor shading devices in a wireless manner.

14. The outdoor shading system, as recited in claim 12, wherein said remote control system further comprises a wireless link for wirelessly connecting said control modules with said central control unit to form said control network in a wireless manner, wherein said wireless link comprises a plurality of first communication links operatively linked to said control modules respectively, and a second communication link operatively linked to said central control unit to wirelessly communicate with said first communication links, such that said central control unit synchronously activates said outdoor shading devices to concurrently control said operation of said outdoor shading devices in a wireless manner.

15. A method of remotely controlling a group of outdoor shading devices, which comprises the steps of:
(a) providing a plurality of control modules at said outdoor shading devices respectively, wherein an operation of each of said outdoor shading devices is controlled by said respective control module;
(b) remotely linking a central control unit to said control modules to form a control network of said outdoor shading devices; and
(c) synchronously activating said control modules to concurrently control said operation of said outdoor shading devices in responsive to an environmental change of said control network.

16. The method as recited in claim 15 wherein, in the step (c), said outdoor shading devices are synchronously actuated to move between an unfolded position and a folded position.

17. The method as recited in claim 16 wherein, in the step (c), said outdoor shading devices are synchronously actuated to adjust the orientations of said awning frames of said outdoor shading devices in responsive to a direction of sunlight.

18. The method, as recited in claim 17, further comprising a step (d) of detecting the environmental change of said control network via an environmental sensor device, wherein said outdoor shading devices are synchronously activated to be operated to automatically adjust said awning frame in responsive to the environmental change of said control network.

19. The method, as recited in claim 18, wherein said environmental sensor device is selected from the group consisting of a sunlight detector for detecting the direction of sunlight, a GPS circuitry for automatically tracking the direction of the sun, a wind detector for detecting the direction of the wind loading at said awning frame, a motion detector for detecting the presence of a user within a detecting area of said respective outdoor shading device, a light module for detecting a light level of an environment of said outdoor shading device to illuminate said shading area thereof, a sound module for generating an audio effect when said respective outdoor shading device is in use.

20. The method, as recited in claim 19, wherein the step (d) further comprises the steps of:
(d.1) configuring one of said outdoor shading devices to form a primary outdoor shading device of said control network by locating said environmental sensor device thereat;
(d.2) configuring the rest of said outdoor shading devices as a plurality of slave outdoor shading devices; and
(d.3) activating said primary outdoor shading device to be operated in responsive to the environmental change of said control network, wherein said slave outdoor shading devices are correspondingly operated in relation to said primary outdoor shading device.

21. The method, as recited in claim 20, wherein the step (b) further comprising a step of wirelessly connecting said control modules with said central control unit to form said control network in a wireless manner, such that said central control unit synchronously activates said outdoor shading devices to concurrently control said operation of said outdoor shading devices in a wireless manner.

22. A remote control system for controlling two or more outdoor shading devices in which each of said outdoor shading devices comprises a supporting frame and an awning frame movably supported by said supporting frame to define a shading area under said awning frame, wherein the remote control system comprises:
a plurality of control modules for providing at said outdoor shading devices respectively to control an operation of said outdoor shading devices; and
a central control unit remotely linked to said control modules to form a control network of said outdoor shading devices, wherein said central control unit is adapted for synchronously activating said outdoor shading devices to concurrently control said operation of said outdoor shading devices in responsive to an environmental change of said control network.

23. The remote control system, as recited in claim 22, wherein each of said control modules comprises an awning folding arrangement operatively linked to said awning frame of said respective outdoor shading device to selectively actuate said awning frame between an unfolded position and a folded position, in such a manner that when said central control unit is remotely activated, said outdoor shading devices are synchronously actuated to move between said unfolded position and said folded position.

24. The remote control system, as recited in claim 23, wherein each of said control modules further comprises an angular joint coupling at said awning frame of said respective outdoor shading device to selectively adjust an orientation of said awning frame in responsive to a direction of sunlight, in such a manner that when said central control unit is remotely activated, said outdoor shading devices are synchronously actuated to adjust the orientations of said awning frames.

25. The remote control system, as recited in claim 22, wherein said central control unit comprises a control panel, having a plurality of preference settings, remotely linked to control modules for synchronously activating said outdoor shading devices in responsive to said preference settings.

26. The remote control system, as recited in claim 24, wherein said central control unit comprises a control panel, having a plurality of preference settings, remotely linked to control modules for synchronously activating said outdoor shading devices in responsive to said preference settings.

27. The remote control system, as recited in claim 22, wherein said central control unit comprises an environmental sensor device operatively linked to said control modules for detecting the environmental change of said control network in such a manner that said outdoor shading devices are synchronously activated to be operated to automatically adjust said awning frame in responsive to the environmental change of said control network.

28. The remote control system, as recited in claim 26, wherein said environmental sensor device is selected from the group consisting of a sunlight detector for detecting the direction of sunlight, a GPS circuitry for automatically tracking the direction of the sun, a wind detector for detecting the direction of the wind loading at said awning frame, a motion detector for detecting the presence of a user within a detecting area of said respective outdoor shading device, a light module for detecting a light level of an environment of said outdoor shading device to illuminate said shading area thereof, a sound module for generating an audio effect when said respective outdoor shading device is in use.

29. The remote control system, as recited in claim 22, wherein said remote control system further comprises a wireless link for wirelessly connecting said control modules with said central control unit to form said control network in a wireless manner, wherein said wireless link comprises a plurality of first communication links operatively linked to said control modules respectively, and a second communication link operatively linked to said central control unit to wirelessly communicate with said first communication links, such that said central control unit synchronously activates said outdoor shading devices to concurrently control said operation of said outdoor shading devices in a wireless manner.

30. The remote control system, as recited in claim 28, wherein said remote control system further comprises a wireless link for wirelessly connecting said control modules with said central control unit to form said control network in a wireless manner, wherein said wireless link comprises a plurality of first communication links operatively linked to said control modules respectively, and a second communication link operatively linked to said central control unit to wirelessly communicate with said first communication links, such that said central control unit synchronously activates said outdoor shading devices to concurrently control said operation of said outdoor shading devices in a wireless manner.
